(19) United States
(12) Patent Application Publication
(10) Pub. No.: US 2005/0021756 A1
(43) Pub. Date: Jan. 27, 2005

(54) Method of developing, delivering and rendering network applications

(76) Inventor: Bruce K. Grant, Pleasant Grove, UT (US)

Correspondence Address: J. Harrison Colter, Suite 310, 333 South 520 West, Lindon, UT, 84042, US

(21) Appl. No.: 10/627,464

(22) Filed: Jul. 26, 2003

(51) Int. Cl. G06F 15/173

(52) U.S. Cl. 709/226

(57) ABSTRACT

A method for developing, delivering and rendering robust graphical applications over a local or wide-area network using industry standard protocols is disclosed. A rich-thin-client comprising scripts written using standard protocols is loaded on a standard browser enabling the browser to emulate a full desktop or windowing application environment. Applications written using a WebFace markup language are then uploaded to the user's computer and run on the rich-thin-client within the user's browser program. The user experiences rapid response times, a rich graphical user interface, the ability to manipulate data in ways consistent with a robust application running on a local operating system, and the ability to interact with services and data located on remote networks without running proprietary software or applets on either the server or the user's client computer.

### BACKGROUND

This invention relates generally to processes for developing and delivering robust applications across networks, including the Internet, and providing a rich graphical user interface consistent with standard windowing environments without the need for proprietary server or client-side software.

Computer networks have been a boon to information sharing in modem society and business. Computer users are able to access network resources to obtain and process useful data and to communicate with other computer users. These networks include local area networks, company wide networks, and wide area networks including the vast world-wide web.

Computer users access and exchange massive amounts of data with other users and with network servers and web servers, including email, text files, web pages, and a variety of binary objects such as audio and video. Networks and the world-wide web have developed tremendously over the last few years to provide: constantly changing and updated information and even the ability to dynamically create and distribute web pages and other information from real-time data. However, the ability to deliver applications across networks has not progressed as rapidly as other technologies, perhaps because of a lack of standards supporting robust application development and delivery and the associated need for proprietary server-side and client-side software to manage the delivery and display of non-standards-based applications. This type of application delivery is further complicated by the difficulties in maintaining, evolving, and upgrading a system that is distributed to thousands or millions of individual computers using a wide variety of hardware and software platforms.

Previously, several attempts have been made to deliver a rich graphical experience using low-density data that is capable of being transmitted over relatively slow bandwidth networks (including the Internet). Standard text-based protocols such as HTML (hyper-text markup language) embed simple commands, text, graphics, and other binary objects, that are converted to a graphical experience via the capabilities of a standard web browser. This approach, however, forces a flat model and is not suitable for interaction with sophisticated user input or the powerful server-side processing capacity that is required to implement a robust application. Typically, this model does not allow much if any of the uniformity in presentation that users of windowing operating systems have come to expect in a robust application environment.

To overcome the limitations of the flat HTML world, applets were introduced into the Internet arena. More robust engines provided by JAVA and other proprietary plug-ins showed some promise of what could be accomplished, but have failed to drive a significant increase in the usability of applications across networks for several reasons. The applet approach has caused the proliferation of many proprietary engines that tie into the user's browser. Applets rely too much on the native operating system and graphical presentation environment and are thus not always portable across platforms. Also, creating and distributing proprietary applet engines created installation, integration, versioning, upgrade, and security issues.

Thus, the ability rapidly to deliver robust applications across networks, and particularly over the vast world-wide-web, is useful because it allows the rapid manipulation of data and interactive participation in dynamic processes rather than the more static view and exchange of simple data that has previously been used on the Internet. The utility of such a process is greatly enhanced by the ability to effect such delivery from any currently existing network or Internet server to any number of computers located anywhere in the world, without the need for any specific operating system, application software, applets, drivers, or protocols other than those included with a standard Internet browser.

### SUMMARY

According to the present invention, a method is provided that allows the development and delivery of robust graphical applications across networks, including the Internet, utilizing current standard protocols and without the need for specialized server-side or client-side software. The method permits the orderly and structured development of complex graphical programs and delivery of such programs from any network or Internet server capable of storing binary data to any client computer connected to such network and capable of operating a web browser that implements standard protocols, with the same look and feel offered by today's windowing operating systems. The method may be used to simulate an entire graphical desktop environment similar to those presented by modem windowing enabled operating system, and to run complex graphical or data-intensive applications either within such a desktop environment or on a stand-alone basis.

The invention comprises a method for generating and distributing robust applications using a high level language called the Web-Face Markup Language (“WFML”). The WFML generates robust applications by assembling a “rich thin-client” on the user's browser at run time through the delivery of pre-built components, then running the desired application on this rich thin-client. No special client-side software is required because the rich thin-client is delivered using standard protocols recognized by virtually all browsers.

Simply accessing a WFML application on the network commences a bootstrap process that loads the WFML framework on the user's computer without the need for any pre-installed software other than a standard browser. Once loaded, the user can run WFML applications on the standard browser, experiencing the same look and feel and the same data manipulation capabilities typical of a full windowing environment. This is possible because the WFML system includes the capability to (1) create visual object definitions; (2) manipulate data in complex ways; (3) interact with a user through an event driven interface; and (4) interact with server side logic. The actual delivery of the WFML application is through Javascript code, XML and other standard protocols that are interpreted and executed at runtime by the Javascript interpreter and other functions already present in a standard web browser. Ultimately, the browser converts everything to standard hyper-text markup language (HTML) sequences for display on the user's computer screen.

The visual definition capability of the system, as well as its uniformity in presentation, is based on a robust set of pre-built components, such as text windows, image windows, input boxes, buttons, and controls. Configurable attributes define the appearance and function of each component. The programmer developing a WFML application has complete control over the layout and appearance of each component, including fixed or relative position, size, color, and other attributes. The WFML facilitates a component hierarchy wherein one component may contain other components, without any practical limit. The creation and manipulation of visual components is based on standard object-oriented programming models, allowing replication of objects (instantiation) and inheritance of characteristics by one object (a child object) from another (the parent object).

WFML allows the flexible description of data relationships, giving a WFML program the power and flexibility of client-based applications. Data relationships are defined to allow data input on the client side to be processed using business logic embodied in the server side of the WFML application. The WFML application can also create persistent data sets that remain on the client computer for rapid access, local processing, and transmission to server side processes.

Data may be dynamically linked to a defined view that is presented to the user with the graphical capabilities of the WFML's rich thin-client. Once linked, the pre-defined view is always accessible. A change in the view dynamically changes the data set and vice versa. Unlike typical HTML-based browser views that regenerate the entire graphical view if any element is changed, the WFML rich thin-client updates only the changed portion of the graphical presentation, enabling a much faster screen refresh and mirroring the performance found in standard client-based applications that run on robust operating systems.

Interaction between the user and the WFML application is event driven using acknowledged standards such as W3C and XML that allow simple and concise descriptions of events. This allows the user to experience the same type of interaction typical of robust client side applications and ensures interoperability and integration with third party components.

The WFML system allows the application running on the rich thin-client nested within the user's standard browser to exchange data with the server side of the WFML application in order to process data from the client, deliver additional data from external sources, or directly with any web service, no matter where it is deployed. This is accomplished without coupling to hard-coded programming on the server side, but through a set of request brokers that describe the connection to be made into other web services (as opposed to connection into specific applications), such as Sun's JAVA or Microsoft's .NET (dot-NET) capabilities.

The power and ease of use of the WFML framework arises from a large set of pre-built components that are commonly used in graphical interfaces and client side applications. These include non-visual components and visual components or “widgets” that allow for moving and sizing of windows, selection of items from lists, creation of menuing options, editing of text, display of graphics, and other actions. Having a pre-built set of structurally related components also facilitates a rapid development environment in which WFML applications can be created using a sophisticated graphical interface and a drag-and-drop approach. Rather than programming, a WFML developer “wires” together and configures pre-existing components to create sophisticated applications that are ready to be installed on a server and delivered over a network to any standard browser without special installation of runtime or other software on either the server or the browser.

In combination, these capabilities of WFML allow the creation of robust applications that reside on a network or Internet server as simple files—not as executing programs. A user connected to the network may access the application simply by clicking on a button that appears inside a normal static HTML based web page. This initiates the loading the WFML's rich thin-client, consisting of a set of scripts already understandable to the user's browser program. The scripts comprising the WFML application are then loaded and run, providing the user with a rich graphical and interactive application or a full desktop environment.

### BRIEF DESCRIPTION OF THE DRAWINGS

Other features and advantages of the present invention will be apparent from reference to a specific embodiment of the invention as presented in the following Detailed Description taken in conjunction with the accompanying Drawings, in which:

FIG. 1 depicts a typical HTML page presentation in a standard browser,

FIG. 2 depicts a notification to download a plug-in application;

FIG. 3 depicts a WFML based application displayed on a standard browser using the rich thin-client technology;

FIG. 4 is a schematic representation of network communication by which WFML applications may be delivered;

FIG. 5 is a flowchart showing the initial bootstrap process required to access a WFML application;

FIG. 6 is a flowchart showing the standalone bootstrap process;

FIG. 7 is a flowchart showing the sibling bootstrap process;

FIG. 8 is a flowchart showing the dependent bootstrap process;

FIG. 9 is a flowchart showing the rendering engine process;

FIG. 10 is a flowchart showing the cached instance rendering process;

FIG. 11 depicts the process for rapidly creating distributed applications using the WFML platform;

FIG. 12 depicts the request broker architecture; and

FIG. 13 depicts the modular model of the WFML development environment.

### DETAILED DESCRIPTION

As used herein, the term “WFML” stands for web-face markup language, a computer application description language that allows the assembly of applications from at set of pre-built components at a high level of abstraction that may be described as wiring rather than programming the application.

According to the present invention, a method is provided that permits the development and delivery of robust, graphical applications to a standard web browser over local and wide-area networks using industry standard communications and applications protocols and without the need for pre-installed server or client software. The method allows a computer user running a standard web browser on standard operating system to access and run complex and graphically rich applications similar to those that run on powerful local operating systems. This is accomplished using the web browser's inherent capabilities to load and run a set of scripts comprising a rich-thin-client, and then to load and run one or more applications written in a web-face markup language recognized by the rich-thin-client or to emulate an entire graphical desktop environment.

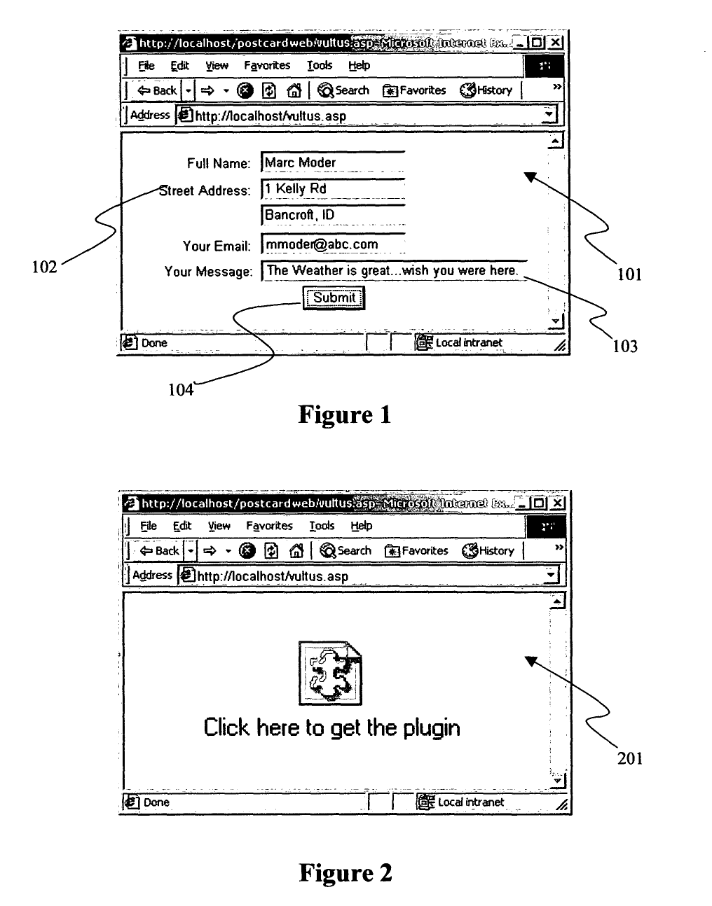

FIG. 1 depicts a typical web-page form, a screen from an interactive web browser session. Objects on the screen are generated using standard HTML (hyper-text mark-up language) scripts to define the layout 101, text 102, fill-in text boxes 103, and an action button 104 the user may click to “mail” an electronic post-card. While the HTML protocol allows the browser to “paint” the desired objects on the computer user's screen, it lacks the power and flexibility required to serve as a platform for web-based enterprise computing in the business-to-business, business-to-consumer, and other electronic commerce markets. Thus, while HTML serves adequately as a final drawing palette and can create images that superficially resemble those of a more robust applications, as FIG. 1 depicts, it lacks the underlying functionality to serve as a platform for robust application development.

HTML-based applications require a user to cycle through a series of flat pages in a manner that is totally unlike the rich, flexible, and interactive experience of using an application running on a local windowing environment such as Microsoft Windows, Linux KDE, or Apple's OS. Also, while a typical windowing environment presents a consistent look and feel in both presentation and interaction, HTML web page design is not governed by any standards, resulting in a different look and feel and different modes of interaction for millions of web pages accessible over the Internet.

Because of these characteristics of HTML, the present invention uses the HTML protocol only as a final rendering engine to place the graphical elements, text, boxes, and other visual characteristics by converting a WFML based application to HTML only at render time. The underlying functionality, graphical look and feel, graphical objects, text, and communication and data interaction functions are all implemented within the WFML application and delivered to the browser in a stream of HTML scripts. The browser then renders on the screen the appearance and functions defined in the WFML application.

The WFML system is distinguished from plug-ins, which are well known and often used in the industry to overcome the weaknesses of HTML. Plug-ins, such as Java applets, Shockwave, and Flash, are software applications that work in conjunction with a standard web browser to enhance the browser's ability to delivery functionality by running specialized application programs within the browser environment. The plug-ins are designed to be delivered over networks with a relatively narrow bandwidth, such as the Internet.

Plugins must be present to generate the screens and objects defined in the specialized application. Companies and individuals desiring to create a more graphically rich and user-interactive experience over a network use proprietary software to develop plug-ins that take advantage of the functionality of the associated specialized application. When a user encounters a web-page that has a plug-in embedded in it, the browser checks to see whether the required specialized application engine is already installed.

If the correct version of the plug-in is already present and registered within the browser, the plug-in application executes within the browser. If the plug-in is not present, the user must download the plug-in and install it before the custom plug-in application can be run. FIG. 2 depicts a web page 201 inviting a user to load a new plug-in. Plug-in engines are typically much larger than the custom plug-in applications they serve and, depending on the speed of the user's network connection, could take many minutes or even hours to load. Thus, many users may not have quick access to a web page that uses embedded plug-in engines.

Use of plug-in engines also creates versioning problems because the plug-ins are constantly undergoing further development. Plug-ins attach themselves not only to the user's browser but directly install the user's operating system. Thus, plug-ins may execute differently when used with different operating systems or different browsers.

Plug-ins also create inherent integration problems as different versions are required for different operating systems and different browser applications. Security, another important consideration for commercial applications to be run across networks, may be compromised because plug-ins may bypass the standard security model implemented by the browser. The proliferation of proprietary plug-ins clutters the user's browser base with large add-on programs, any of which may be constantly updated but with no central source to maintain compatibility and integration, all the while providing no assurance that a required or desired web application can be run the first time the user encounters it. Moreover, a user accessing a plug-in based application from a new computer, or from a browser at a remote site, may need to reload the plug-in each time, a time-consuming and cumbersome process that defeats one of the greatest advantages of browser-based network applications, that of portability.

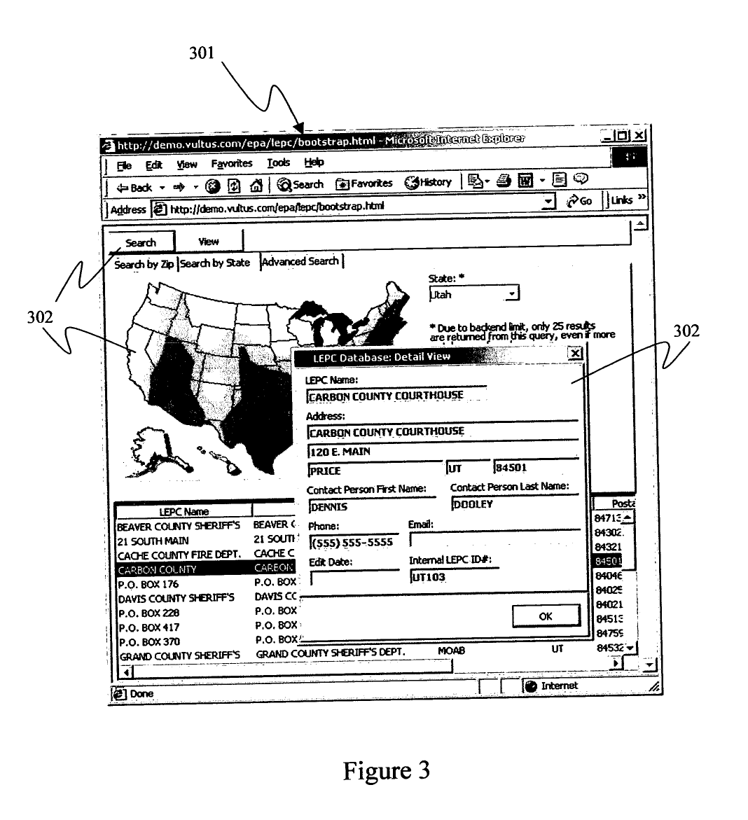

In contrast, FIG. 3. depicts a display 301 generated by the rich-thin-client enabled by the present invention. A rich-thin-client is a small application that, unlike a plug-in, can be delivered over a limited band-width network and interpreted directly by a standard browser without the installation of executable software on the user's computer. The rich-thin-client of the present invention allows a standard browser to present a graphically rich user interface within a standard browser, or as a stand-alone application that, while using the browser's inherent capabilities, appears to be running as an independent application.

The rich thin-client provides its own set of graphical objects 302 and need not rely on any elements of the user's operating system and thus provides a consistent look and feel across operating systems and browsers. These graphical objects 302 are translated into HTML and rendered by the browser. While the displays depicted in FIG. 1 and FIG. 3 are both rendered by a standard browser, the relative sophistication of the display 301 in FIG. 3 is based on the ability of the WFML application to deliver pre-built components by translating them to HTML and delivering them to the browser's HTML engine at render time.

As depicted in FIG. 3, the built-in functionality of the rich-thin-client allows a full graphical user experience including multiple windows, text, graphics, menus, buttons, and even emulation of a complete desktop environment, using only the functionality inherent in a standard browser to render the application and accept user input. Applications designed to run under the rich-thin-client are written in the WFML and comprise scripts written in industry standard protocols including Javascript and XML. The size of a WFML application is typically similar to that of a standard set of HTML web pages and thus can be loaded quickly even over narrow bandwidth network connections such as a modem.

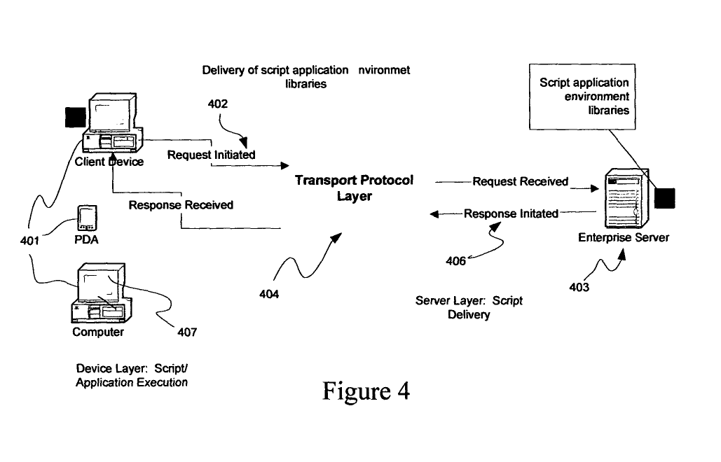

FIG. 4 shows the initiation of a web communication session in which a computer user connected to the Internet through a client device 401 commences a web communication session that includes a WFML application. The user identifies a URL (universal resource locator) either by typing the URL into the appropriate text box on the user's browser or by linking to the URL by clicking on a link in an existing web page displayed on the browser. An example of a URL pointing to a WFML application is:

http://demo.vultus.com/demos/40rc1/app/calculator/′,%20‘CalculatorDemo’,%20365,%20260)

Entering a URL initiates a request 402 that is routed to an enterprise server 403 referenced by the URL over the Internet or other transport protocol layer 404 as is known in the art. The URL is resolved by a designated DNS server as is known in the art and the request is received by the enterprise server 403 that hosts the requested URL.

The enterprise server 403 interprets the request as a request to deliver the server data associated with that URL, typically a text script written to comply with the HTML protocol or other protocol that can be interpreted and displayed by a standard browser. The host initiates its response 406 and transmits the script identified by the URL request which is routed to the client device 401. When received by the client device 401, the response is interpreted by the user's browser, and displayed on a display screen 407. Of course, other client devices, including additional client computers, network enabled PDAs (personal digital assistants), and cellular telephones may be used to send and receive responses that result in the delivery of WFML applications as contemplated by the present invention.

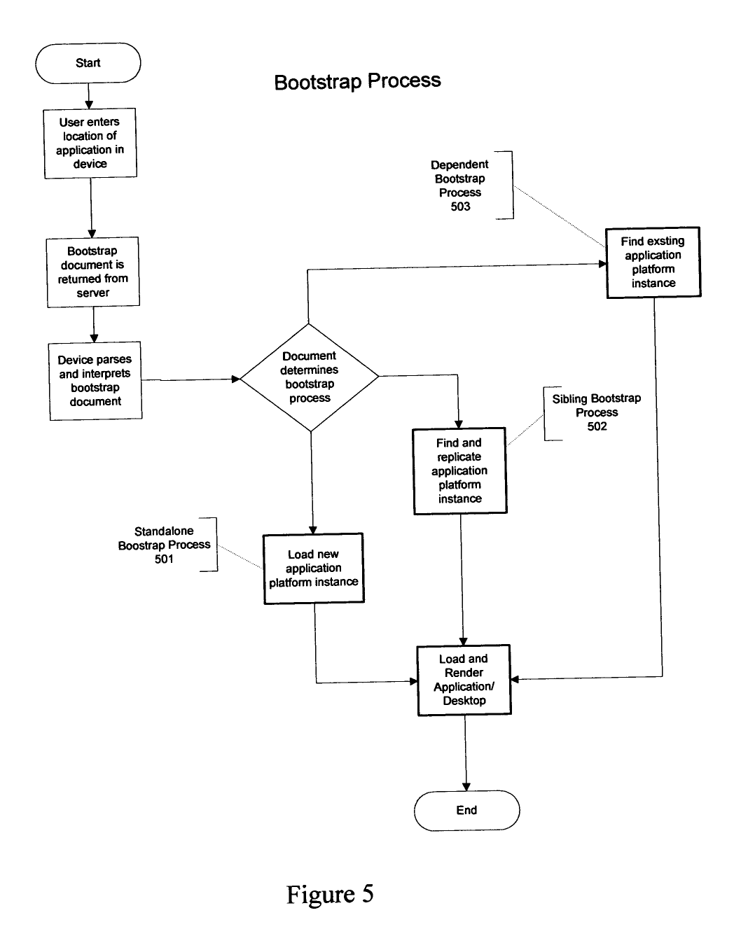

As depicted in the flowchart shown in FIG. 5, when the URL entered by the user identifies a web site featuring an application written in WFML, a bootstrap process is initiated to deliver to the client all scripts that are required to enable the user to load and access the WFML application. First, the user enters the location of the application, generally its URL, in the browser running on the client device. The URL identifies a server and a specific document residing on the server. This document, which is returned to the client device by the server, is the bootstrap document that initiates further steps to load and implement a WFML application. In one embodiment, the bootstrap document is an HTML page that may be parsed and interpreted by a standard browser running on the client device. As is known in the art, the HTML page may contain other embedded scripts and documents that can be interpreted by a standard browser, such as XML and Javascript code.

The bootstrap HTML page contains additional instructions written in Javascript that are parsed and interpreted by the browser in the same manner that the browser parses any other web page. The scripts embedded in the bootstrap document determine which bootstrap process will be followed. This determination is based on the nature of the WFML application identified in the URL and the current state of any WFML applications already resident on the user's browser from currently active or previously active sessions that accessed the same WFML applications or different WFML applications. Specifically, the bootstrap process determines which configuration is required.

If there are no preexisting or current sessions of a WFML application running on the user's browser, a standalone bootstrap process 501 is initiated. This process loads those portions of the WFML platform's rich thin-client required to run the application. If the application identified by the URL is the same as one already running on the user's browser, a sibling bootstrap process 502 is initiated in which the user's browser locates and replicates a new instance of the existing application. If the application identified by the URL is subordinate to an existing WFML application running on the user's browser, a dependent bootstrap process 503 is initiated in which the identified application will run on an existing instance of the WFML platform.

Under each of these alternatives, the bootstrap document defines which components are resident on the user's computer, which need to be replicated from resident components, and which components must be newly loaded from the server. Upon completion of the appropriate bootstrap process, the application is loaded and rendered on the user's browser. The application may be a stand-alone application or a full desktop environment on which other applications will subsequently be loaded and executed. The distinction is a nominal one because the WebFace desktop is an application that looks and behaves like a desktop environment in an operating system that features a windows-based graphical user interface.

The WFML platform supports caching as is known in the art. If all or portions of documents or scripts required in any of the bootstrap processes is already resident in an internal cache, such as those maintained by the operating system, the browser, or by the WFML platform itself, those documents or scripts may be retrieved from cache rather than from the server. Caching may be enabled or disabled from within a WFML application or by the user.

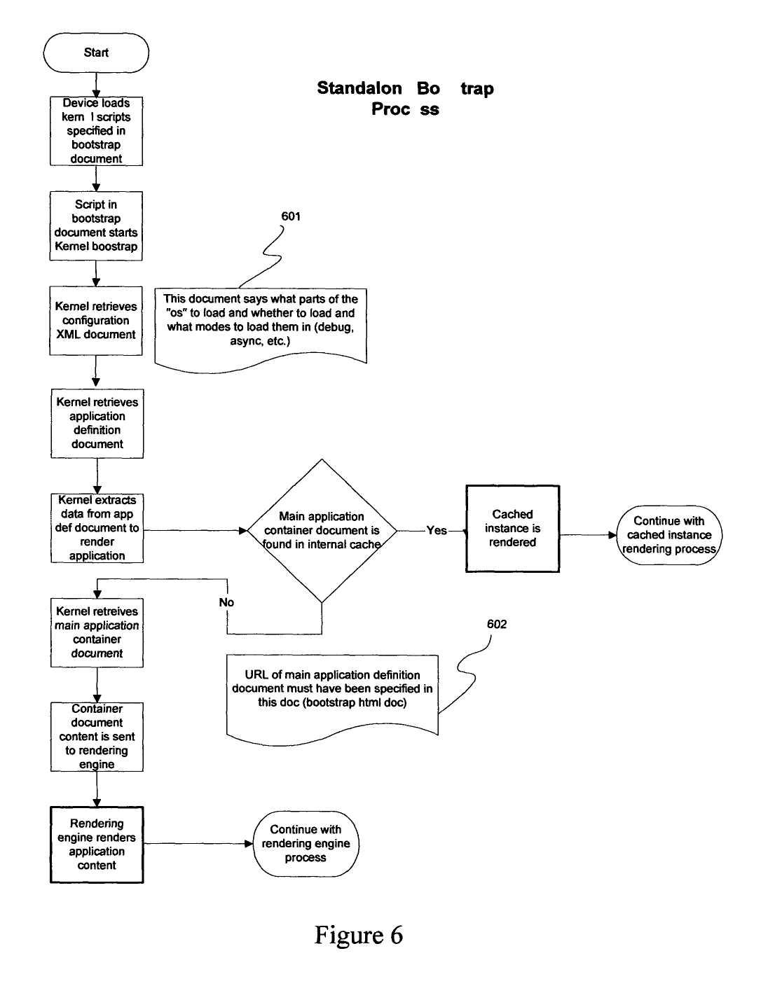

FIG. 6 depicts a flowchart showing the detailed steps of the standalone bootstrap process 501 that is invoked the first time a user accesses a WFML application. The user's client device first loads the kernel scripts identified in the bootstrap document. These scripts, written in Javascript in the presently described embodiment, initiate the kernel bootstrap process. The kernel scripts comprise those functions basic to all WFML applications. When loaded, the bootstrap process continues with execution of kernel scripts that, in turn, retrieves a configuration document, such as an XML document in the current embodiment.

The configuration document 601 describes what parts of the WFML platform need to be loaded to run the application being retrieved. The configuration document 601 also determines in what modes to load the necessary portions of the WFML platform. Like typical robust operating systems, the WFML platform may be loaded or configured in a number of modes depending on the use to which the platform and application will be put. Supported modes include a debug mode, asynchronous mode, and others as is known in the art.

When the configuration document 601 has been parsed, the kernel retrieves an application definition document 602 that defines the graphical and functional elements of the application. The kernel extracts the data required to render the application from the application definition document 602. The first part of this process is to create an independent instance or container for the application. If the container is in internal cache, the instance of the application stored in cache will be rendered as described below. If the main application container document is not found in cache, the document defining the main application container that was identified in the application's URL is retrieved from the server. The document content defining the application is then rendered by the WFML rendering engine as described below.

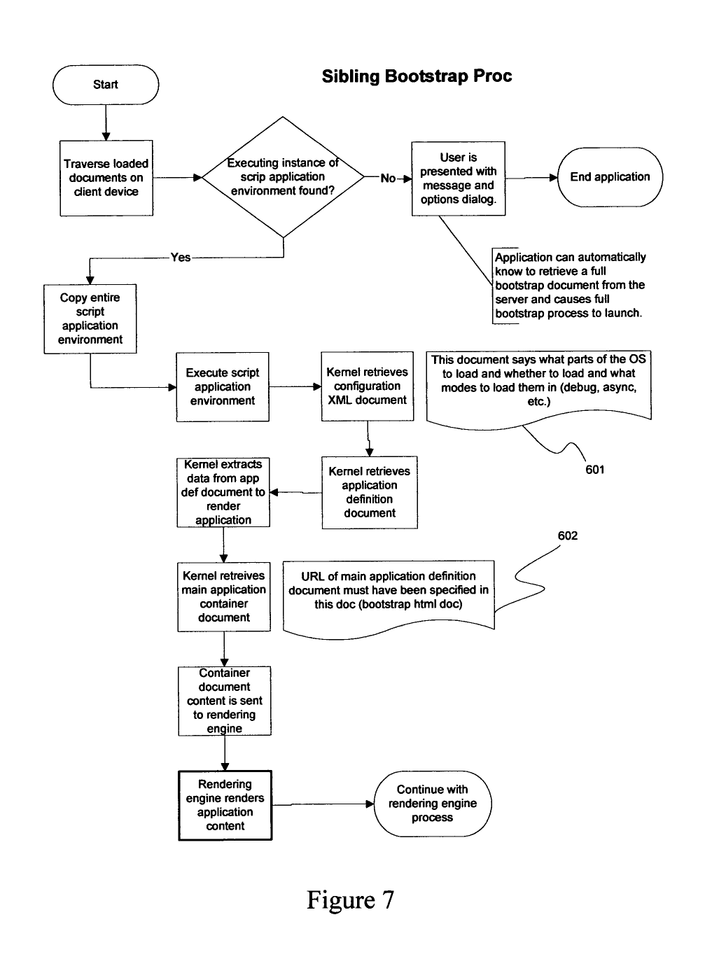

FIG. 7 depicts the sibling bootstrap process 502 in flowchart format. This process provides an efficient and rapid method to start multiple instances of an application or portions of an application, which is a common requirement in robust applications, such as those where multiple documents are viewed, edited or compared. By opening multiple instances of an application, the sibling bootstrap process allows separate applications, windows, and even entire desktops to be opened and dosed independently, much as is done with robust windowing operating systems. A key advantage of the sibling bootstrap process in a network environment is that the need to reload large amounts of data with limited bandwidth capacity can be eliminated.

As described above and depicted in flow chart form in FIG. 7, this process is invoked when the document retrieved from the URL selected by a user indicates that a second or other multiple instance of an existing application is to be executed. The process begins with the client device 401 traversing all loaded documents to determine if an instance of the requested application is resident on the client device. If the original instance is not resident on the client device, the user can be presented with a message and a dialog box instructing the user as to available options. These options may include ending the program or commencement of the standalone bootstrap process 501 depicted in FIG. 6. The WFML application may be also configured to automatically commence the standalone bootstrap process if the expected instance to commence the sibling bootstrap process is not resident on the client device.

When the sibling bootstrap process 502 locates an existing, executing instance of the application, the scripts for the application environment are replicated and then executed. Once the environment is executing, the bootstrap process continues with the same steps described in FIG. 6, wherein the kernel retrieves the configuration document, loads any additional components required for the new instance of the application, sets the proper execution modes, and retrieves and interprets the application definition document and submits it to the rendering engine.

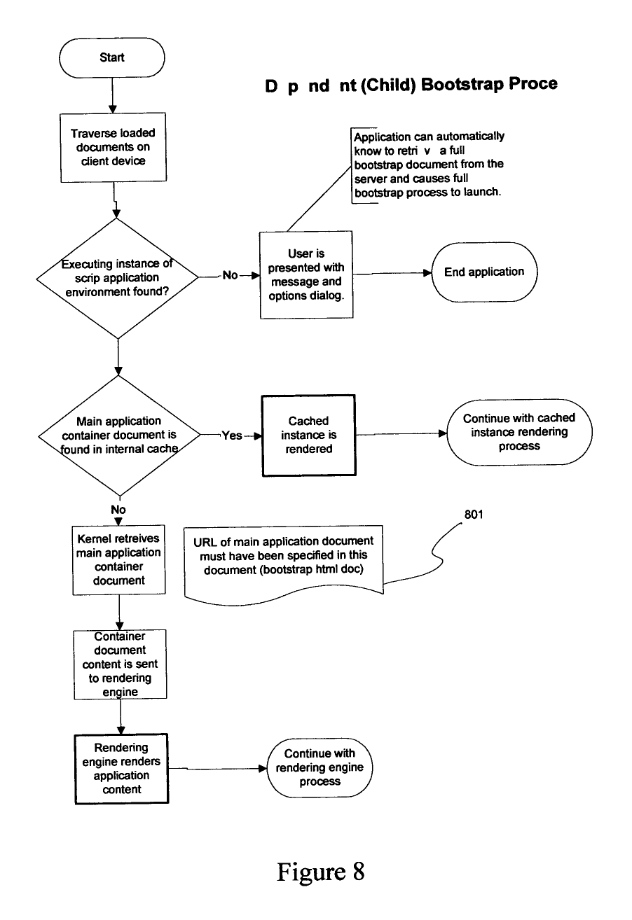

FIG. 8 depicts the dependent bootstrap process 503 in flowchart format. As described above and shown in FIG. 5, this process is invoked when the document retrieved from the URL selected by a user indicates that a dependent or “child” instance of an existing application is to be executed. As with the sibling bootstrap process, the dependent bootstrap process begins with the client device traversing all loaded documents to determine if an instance of the requested application is resident on the client device. If the original instance is not resident on the client device, the user may be presented with a message and a dialog box advising the user of available options as described with respect the sibling bootstrap process.

When an executing instance of the application environment is located, the dependent bootstrap process checks to see whether the application container document 801 is found in the internal cache created by the WFML platform. If so, the instance residing in the cache is rendered as described below. If the main application container document 801 is not found in cache, the kernel retrieves it from the server as identified in the URL, and submits the application container document to the rendering engine where the application content is rendered on the user's client device 401.

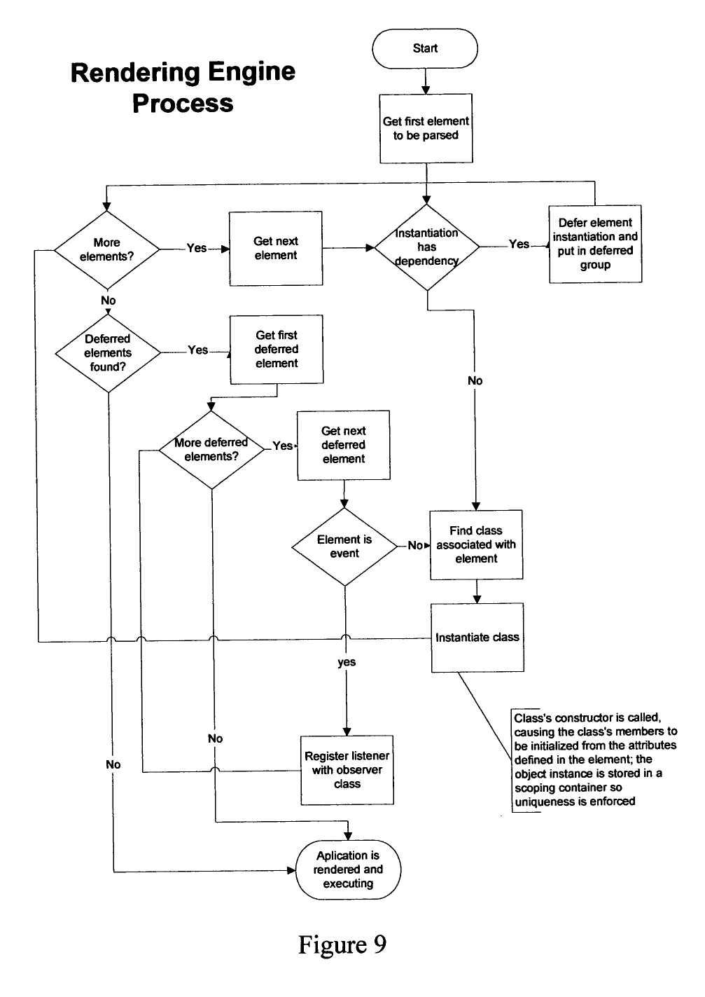

FIG. 9 depicts a flowchart of the rendering engine process. This process parses and processes the various elements of a WFML application in the proper order, ultimately translating the graphical and data elements into their corresponding in-memory WFML objects and HTML sequences. The result is then displayed on a standard browser running on the user's client device.

The rendering engine process commences by retrieving the first element and determining whether its instantiation must be deferred because of dependencies on one or more other elements that have not yet been retrieved. If a dependency is found, that element is put in a deferred group to await later instantiation. If no dependencies exist, the rendering engine finds the class associated with that element and instantiates the class. At this point all graphical, text, functional, and other elements are translated into HTML sequences and displayed in the browser window on the user's client device. After an element is either instantiated using the proper class or deferred for later instantiation, the process checks for additional elements, looping through all elements in the application definition until each has been instantiated or deferred. When all elements have been processed, a test is made to see if any elements have been deferred. If there are none, the application has been fully rendered and is now executing on the user's browser and client device.

If deferred elements are found, the rendering process loops through the deferred elements in a manner similar to that of un-deferred elements. In the case of deferred elements, a test is made to determine if an element is an event (such as a process that detects mouse movement and location or that executes by clicking on a button). When an event is located, the code sequence that defines the event or “listener” is registered with the appropriate observer class (the class that is to receive notification of the event) and the process continues on to the next element. When a deferred element is not an event, it is processed in the same manner as undeferred events, by locating the class associated with that element and instantiating that class. Because the event was deferred, all dependencies will have been satisfied so that such instantiation can take place within the properly established context. For example, an event defined for a click on a button cannot be registered with that button until that button instantiated.

This process continues until all deferred elements have been processed and instantiated and all event-type objects have been registered to allow their respective events to be detected and acted upon in accordance with the programming logic of the WFML application. At this point, the WFML application is fully rendered and executing on the browser running on the user's client device.

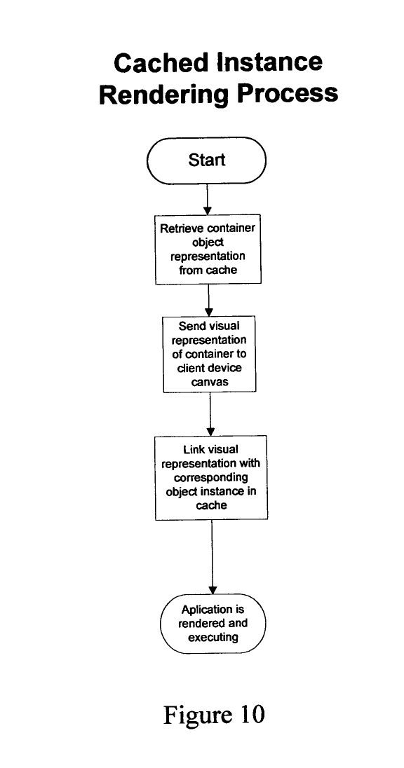

As noted above, one or more elements of a WFML application may already reside in a cache maintained by the operating system or the browser at the time the bootstrap process is implemented. In such cases, as depicted in flowchart format in FIG. 10, the rendering process can be greatly simplified. When an instance of the main application container is found in cache, it is retrieved and a visual representation is sent to the display of the client device. In the case of the browser, the visual representation is simply the HTML rendering of the application elements defined in the WFML application. To make the application retrieved from cache functional, the visual representation is linked to the object instances in the cache, providing for proper handling of events and other processes. At this point the application is fully rendered and executing just as if it had been loaded directly from the server 403.

As described above, WFML applications may comprise text-based scripts written using standard protocols such as HTML, XML, and Javascript. While such scripts can be written using any type of text editor, the advantages of standards-based programming are further extended by the creation of prebuilt classes of standard objects in Javascript and by creation of a comprehensive integrated development environment (IDE). Despite the fact that Javascript runs natively on almost all standard browsers, often Javascript has been viewed as being inappropriate for robust application development and has typically been used for development of relatively small applications.

The WFML platform enables the use of Javascript and other standards to rapidly build robust applications that can simulate the complexity and functionality of applications running on server and client side operating systems. This is achieved by providing the WFML application developer with a fully integrated development environment that allows the application to be wired together from existing, reusable components rather than requiring each element to be independently programed. The WFML development environment uses the concepts of object oriented programming as is known in the art (instantiation, polymorphism, and inheritance).

Object classes are created using industry standard scripts, primarily Javascript in one embodiment of the invention. Characteristics of object classes may be defined and controlled by documents written using the XML protocol. This allows the creation of many unlimited customized objects from a simple code base of master objects.

By creating a library of standard objects, the development of WFML applications takes the form of wiring together and configuring existing elements. This is more efficient than traditional programming approaches that are used with conventional programming language and standards, including those used by the WFML system. This approach also allows sophisticated applications to be built and deployed with limited technical skill or programming expertise.

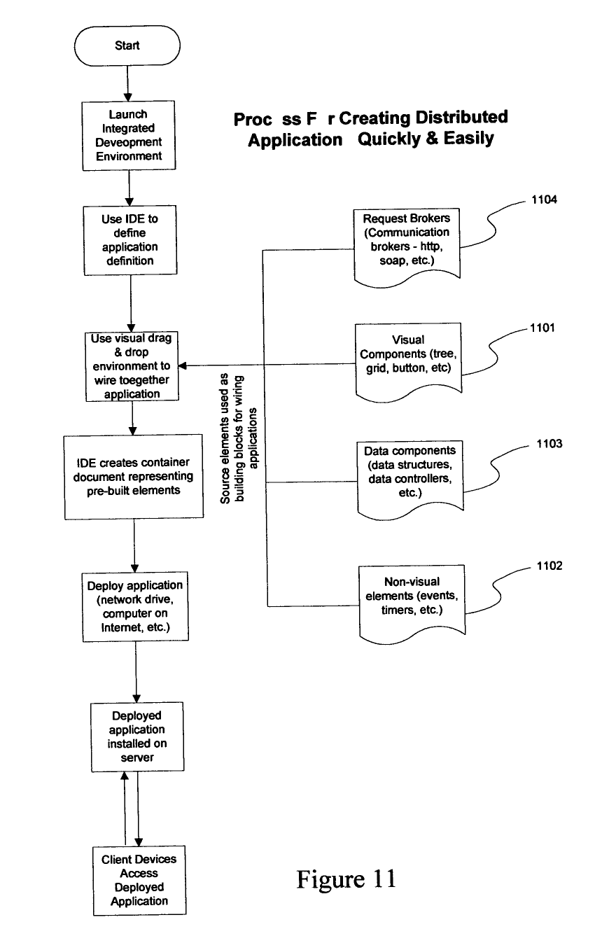

FIG. 11 depicts a flowchart of the process for rapid development of a WFML application. The WFML integrated development environment is launched. This environment is an application that allows the user to define the application and to link together the various elements that will comprise the application. Using the IDE, the user first defines the basic application structure. Using a visual, drag and drop environment, the user places the required elements within the application framework and defines their various properties and relationships.

An unlimited number of source elements may be offered as pre-built elements from which robust applications can be created. FIG. 11 shows four exemplary categories of pre-built objects that are used to create a WFML application. The first category 1101 includes a large library of visual components that are typical of a windowing environment. These include frames, panels, buttons, graphical boxes, text boxes, tree structures, grids, tables, radio buttons, slider controls, and other visual elements. Each general class of visual elements may be configured for size, color, location, number of items, etc.

The second category 1102 of pre-built elements comprises non-visual elements used to provide control and user interaction with the application. These include timers, audible elements, and many types of events that sense button clicks, keyboard input, mouse movement, etc. The third category 1103 includes pre-defined data structures and controllers to simplify the creation of WFML applications that allow distribution, display, and editing of data across networked environments.

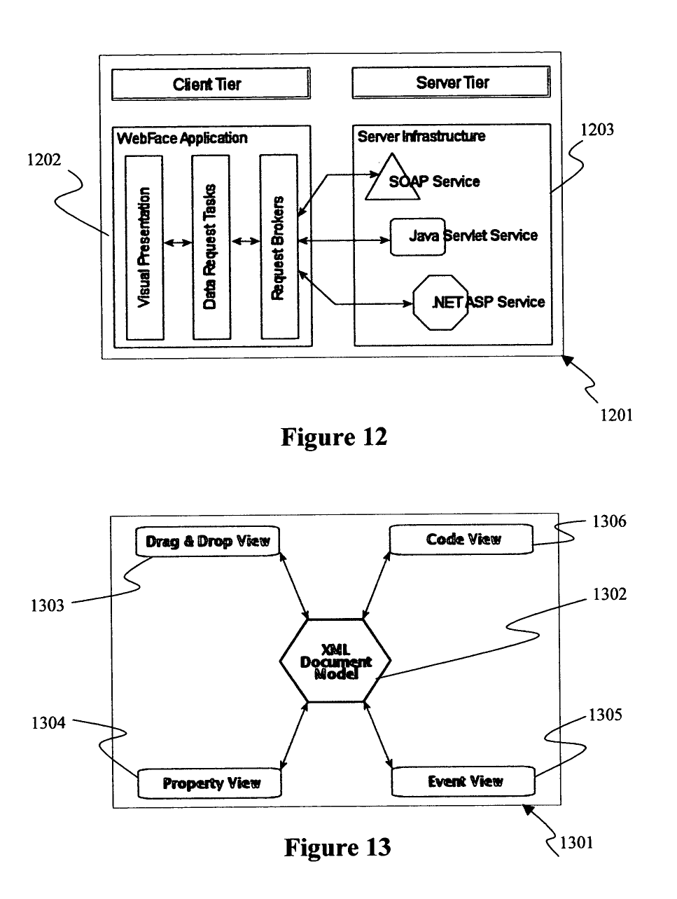

The fourth category 1104 includes specialized elements known as request brokers. These pre-built elements are designed to allow the WFML application to readily communicate with other client and server applications that use standard protocols. Request brokers convert input from elements in the WFML application to formats that can communicate using Internet and network standards such as http (hypertext transfer protocol), SOAP (simple object access protocol), Microsoft's .NET (dot-net), Java servlets, or other similar standards as are known or developed in the art. FIG. 12 depicts the request broker architecture 1201 under which the visual presentation running on the client tier 1202 allows user interaction that transmits and receives data. The request brokers running on the client tier 1202 then use the proper protocols to route requests and associated responses from server tier 1203 services such SOAP, Java servlets and Microsoft.NET.

From the framework created using the four exemplary types of pre-defined elements, the IDE creates the container document representing the various pre-built elements. The IDE then provides for the WFML application to be deployed on a local or network computer, or any network or Internet site accessible to the user. This is valuable for testing the application. Once the user is satisfied with the deployed application, it can be installed on a server 403 where it is exposed to network users who access the fully deployed application using client devices 401.

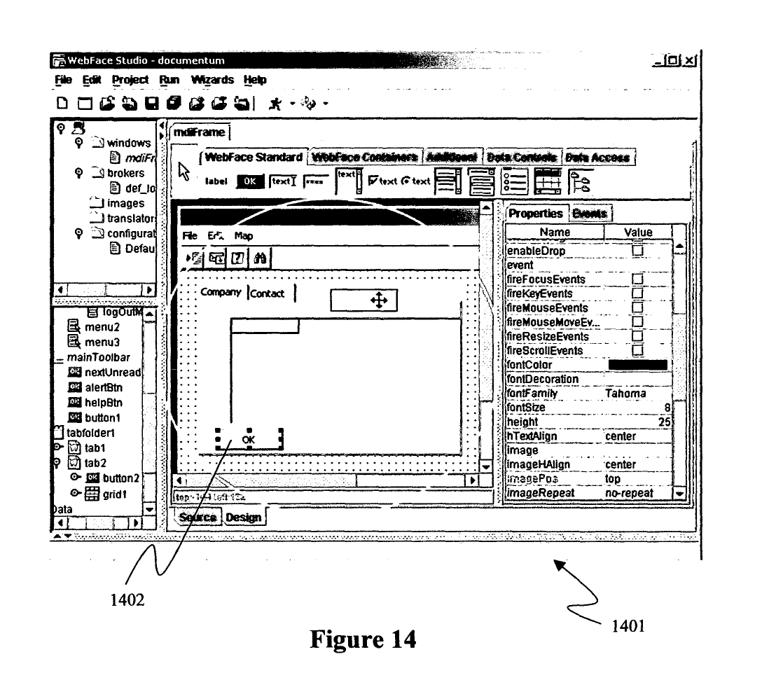

FIG. 13 schematically depicts the application development environment 1301. The application under development is shown as an XML document model 1302, as the end product of the development process is an XML document that includes the pre-defined elements from each of the categories described above their associated properties, events, and code. As the application is created, the developer can view the work in progress using any of the four primary views: (1) drag and drop view 1303; (2) property view 1304; (3) event view 1305; and (4) code view 1306.

Each of these views allows the developer to manipulate the pre-built elements and configure their appearance and behavior using a graphical interface. The WFML development environment creates the text comprising the XML document based on this graphical manipulation. The developer also has direct access to the code when necessary.

FIG. 14 depicts a drag and drop view 1401 of the graphical development environment. In this view, a button 1402 labeled OK has been created by dragging a button from the library of visual components on to the graphical representation of the application under development. The button 1402 may be placed and sized graphically. A list of properties is also available in which the size, color, label and other characteristics of the button 1402 may be seen and edited in text format.

Similar views are available to allow graphical manipulation of the properties of each type of pre-built element (property view 1304) or the events triggered by acting on the various elements (event view 1305). A code view 1306 is also available in which the developer can view, insert, and edit the application under development programmatically. The programming input of the developer may range from editing item properties, such as the size or location of a button, to the addition of complex numerical, text, or graphical manipulation routines similar to those created using traditional programming languages.

The end result of the application development process using the WFML integrated development environment is a document in XML format with other standard protocol scripts, including Javascript, embedded. These scripts include function names, variable names, and other identifiers that are descriptive of their identity or function as is typically done when developing an application in any programming language.

For example, a function might be named GetComponentID and a variable could be EmployeeName. The WFML development environment provides for obfuscation of these identifiers before the application is deployed. The obfuscator replaces each function name, variable name or other identifier with arbitrary one and two letter substitutes comprised of letters, numbers or combinations thereof, such as w, xs, a0, or 9k. In doing so, the WFML development tool ensures that no interdependencies are violated as well as detecting whether certain variables may not be changed because they are used in their full form in some other context. The resulting obfuscated code is reduced in size by a factor of five times or more, providing for greatly reduced storage requirements and reduced download times. The obfuscation also renders the resulting code almost unintelligible. This is useful to a developer of network based applications where the code itself will be freely transferred, but where the methods and algorithms warrant some degree of protection from easy duplication or reverse engineering.

The development environment may also include visual wizards to accelerate the development of complex components, such as menus, grids, and the like.

Thus, the present invention has several advantages over the prior art. It will be obvious to those of skill in the art that the method depicted in the FIGURES and described herein may be modified to produce different embodiments of the present invention. Although embodiments of the invention have been described, various modifications and changes may be made by those skilled in the art without departing from the spirit and scope of the invention.

1. A method for developing, delivering and rendering a network-based computer application on a visual display connected to a network comprising the steps of:
developing a network-based application by a method comprising the steps of:
launching an integrated development environment that includes visual drag and drop capabilities designed to wire application components together;
using the development environment to define the structural and functional requirements of the network-based computer application;
using the visual drag and drop capabilities of the development environment to select at least one pre-built component capable of satisfying one of the requirements of the network-based application, each said component being written in a device independent computer scripting language;
causing the development environment to create a container document that represents the at least one selected pre-built component;
creating a bootstrap process document that may be used to initiate the network-based application, which bootstrap process document is written in a computer language that can be interpreted by a client device; and
deploying the network-based application on a computer that is connected to the network;
delivering the network application to a user by a method comprising the steps of:
storing the network-based application at a predetermined network address;
providing the bootstrap document from the network-based application to a user in response to initiation of a network communication session that identifies the pre-determined network address; and
causing the bootstrap process document to execute on the client device and thereby load the network-based application on the client device;
rendering the network-based application on the visual display of the client device by a method comprising the steps of:
retrieving at least a part of the network-based application into the client device during the network communication session;
causing the at least one pre-built component to be interpreted by the client device;
determining whether the interpreted component has a dependency that has not been satisfied;
if an unsatisfied dependency exists, deferring the interpretation of the component until all components have been loaded;
if no unsatisfied dependency exists, interpreting the component and creating an instance of the component on the client device;
upon completion of the interpretation of all components for which no unsatisfied dependency exists and loading of all components, reviewing each deferred component to determine if the component is an event;
if the deferred component is not an event, interpreting the component and creating an instance of the component on the client device;
if the deferred component is an event, registering the event on the client device in preparation for responding to a predetermined input or condition;
continuing to process components until all components have been instantiated and all events have been registered; and
creating a visual representation on the visual display.

2. The method of claim 1 wherein the pre-built components include at least one of:
a request broker;
a visual component;
a data component; or
a non-visual element.

3. The method of claim 1 wherein the bootstrap process document defines a standalone bootstrap process.

4. The method of claim 1 wherein the bootstrap process document defines a sibling bootstrap process.

5. The method of claim 1 wherein the bootstrap process document defines a dependent bootstrap process.

6. The method of claim 1 wherein the development environment uses a web face markup language.

7. The method of claim 1 further comprising the step of obfuscating at least one identifier prior to delivering the network-based application.

8. A method for developing, delivering and rendering a network-based computer application on a visual display connected to a network comprising the steps of:
developing a network-based application by a method comprising the steps of:
launching an integrated development environment that includes visual drag and drop capabilities designed to wire application components together;
using the development environment to define the structural and functional requirements of the network-based computer application;
using the visual drag and drop capabilities of the development environment to select at least one pre-built component capable of satisfying one of the requirements of the network-based application, each said component being written in a device independent computer scripting language;
causing the development environment to create a container document that represents the at least one selected pre-built component; and
deploying the network-based application on a computer that is connected to the network.

9. The method of claim 8 further comprising the step of creating a bootstrap process document that may be used to initiate the network-based application, which bootstrap process document is written in a computer language that can be interpreted by a client device.

10. The method of claim 8 further comprising the steps of:
storing the network-based application at a predetermined network address;
providing a bootstrap document from the network-based application to a user in response to initiation of a network communication session that identifies the pre-determined network address; and
causing the bootstrap process document to execute on the client device and thereby load the network-based application on the client device.

11. The method of claim 8 further comprising the steps of:
retrieving at least a part of the network-based application into the client device during the network communication session; and
causing the at least one pre-built component to be interpreted by the client device.

12. The method of claim 11 further comprising the steps of:
determining whether the interpreted component has a dependency that has not been satisfied;
if an unsatisfied dependency exists, deferring the interpretation of the component until all components have been loaded;
if no unsatisfied dependency exists, interpreting the component and creating an instance of the component on the client device;
upon completion of the interpretation of all components for which no unsatisfied dependency exists and loading of all components, reviewing each deferred component to determine if the component is an event;
if the deferred component is not an event, interpreting the component and creating an instance of the component on the client device;
if the deferred component is an event, registering the event on the client device in preparation for responding to a predetermined input or condition;
continuing to process components until all components have been instantiated and all events have been registered; and
creating a visual representation on the visual display.

13. The method of claim 8 wherein the pre-built components include at least one of:
a request broker;
a visual component;
a data component; or
a non-visual element.

14. The method of claim 10 wherein the bootstrap process document defines a standalone bootstrap process.

15. The method of claim 10 wherein the bootstrap process document defines a sibling bootstrap process.

16. The method of claim 10 wherein the bootstrap process document defines a dependent bootstrap process.

17. The method of claim 10 further comprising the step of obfuscating at least one identifier prior to delivering the network-based application.

18. A method for developing, delivering and rendering a network-based computer application on a visual display connected to a network comprising the steps of:
storing the network-based application at a predetermined network address;
providing a bootstrap process document from the network-based application to a user in response to initiation of a network communication session that identifies the pre-determined network address; and
causing the bootstrap process document to execute on a client device and thereby load the network-based application on the client device.

19. The method of claim 18 further comprising the steps of:
launching an integrated development environment that includes visual drag and drop capabilities designed to wire application components together;
using the development environment to define the structural and functional requirements of the network-based computer application;
using the visual drag and drop capabilities of the development environment to select at least one pre-built component capable of satisfying one of the requirements of the network-based application, each said component being written in a device independent computer scripting language;
causing the development environment to create a container document that represents the at least one selected pre-built component; and
deploying the network-based application on a computer that is connected to the network.

20. The method of claim 19 further comprising the step of creating the bootstrap process document that may be used to initiate the network-based application, which bootstrap process document is written in a computer language that can be interpreted by the client device.

21. The method of claim 19 further comprising the steps of:
retrieving at least a part of the network-based application into the client device during the network communication session; and
causing at least one pre-built component to be interpreted by the client device.

22. The method of claim 21 further comprising the steps of:
determining whether the interpreted component has a dependency that has not been satisfied;
if an unsatisfied dependency exists, deferring the interpretation of the component until all components have been loaded;
if no unsatisfied dependency exists, interpreting the component and creating an instance of the component on the client device;
upon completion of the interpretation of all components for which no unsatisfied dependency exists and loading of all components, reviewing each deferred component to determine if the component is an event;
if the deferred component is not an event, interpreting the component and creating an instance of the component on the client device;
if the deferred component is an event, registering the event on the client device in preparation for responding to a predetermined input or condition;
continuing to process components until all components have been instantiated and all events have been registered; and
creating a visual representation on the visual display.

23. The method of claim 18 wherein the bootstrap process document defines a standalone bootstrap process.

24. The method of claim 18 wherein the bootstrap process document defines a sibling bootstrap process.

25. The method of claim 18 wherein the bootstrap process document defines a dependent bootstrap process.

26. The method of claim 18 wherein the development environment uses a web face markup language.

27. The method of claim 18 further comprising the step of obfuscating at least one identifier prior to delivering the network-based application.

28. A method for developing, delivering and rendering a network-based computer application on a visual display connected to a network comprising the steps of:
retrieving at least a part of a network-based application into a client device during the network communication session; and
causing at least one pre-built component to be interpreted by the client device.

29. The method of claim 28 further comprising the steps of:
determining whether the interpreted component has a dependency that has not been satisfied;
if an unsatisfied dependency exists, deferring the interpretation of the component until all components have been loaded;
if no unsatisfied dependency exists, interpreting the component and creating an instance of the component on the client device;
upon completion of the interpretation of all components for which no unsatisfied dependency exists and loading of all components, reviewing each deferred component to determine if the component is an event;
if the deferred component is not an event, interpreting the component and creating an instance of the component on the client device;
if the deferred component is an event, registering the event on the client device in preparation for responding to a predetermined input or condition;
continuing to process components until all components have been instantiated and all events have been registered; and
creating a visual representation on the visual display.
